(19) United States
(12) Patent Application Publication
(10) Pub. No.: US 2010/0139336 A1
(43) Pub. Date: Jun. 10, 2010

(54) ADJUSTABLE ANTI-THEFT DEVICE

(76) Inventor: Pietro Necchi, Borgoratto Alessandrino (IT)

Correspondence Address: SHELDON MAK ROSE & ANDERSON PC, 100 Corson Street, Third Floor, PASADENA, CA, 91103-3842, US

(21) Appl. No.: 12/597,901

(22) PCT Filed: May 22, 2007
(86) PCT No.: PCT/IT07/00358

§ 371 Date: Oct. 27, 2009

(51) Int. Cl. E05B 73/00; E05B 65/00; E05B 47/00

(52) U.S. Cl. 70/57.1; 70/58

(57) ABSTRACT

An anti-theft device (1) composes of an adjusting and blocking body (3) and of an abutment plate (5), that are being mutually connected through at least two protecting cables (2) and mutually approaching and going away by unwinding or winding such cables (2) from or on at least one winding coil (6) rotating inside the adjusting and blocking body (3), each cable (2) having both its ends fastened to the winding coil (6) and a central portion thereof passing inside the abutment plate (5), the adjusting and blocking body (3) being equipped with locking and unlocking means of the rotation of such coil (6), and comprising an automatic recovering system for a slack of the protecting cables (2).

The present invention refers to an adjustable anti-theft device, particularly aimed for protecting against the theft of products contained inside voluminous boxes or packages.

Anti-theft devices are known in the art, usually made of transparent polycarbonate, adapted to prevent the theft of compact discs, musicassettes, videocassettes, DVDs, books or the like, arranged inside them during their exhibition for sales. Such cases however have a fixed and reduced internal volume, and therefore are ill suited for protecting products contained in big-sized packages, such as for example shoes, household appliances, etc., and relatively scarcely standardised.

In order to solve the above problems, anti-theft devices are also known that are equipped with a safety coil connected, through a plurality of cables with adjustable length, to an abutment plate, such cables being adapted to surround all sides of a box containing the product to be protected during its exhibition for sales, and that can be opened only by using a suitable dedicated detaching device, generally of a magnetic type, or an uncoupling device available for the service personnel. Such devices can further be protected with safety systems that prevent them from being tampered with, or warn against the breakage of cables, or adhesive Radio-Frequency (RF), electromagnetic (EM) or acoustic-magnetic (AM) labels or their combinations, cooperating with anti-theft detecting barriers. Examples of such known devices can be found in U.S. Pat. No. 3,611,760, U.S. Pat. No. 4,418,551, U.S. Pat. No. 4,756,171, U.S. Pat. No. 4,896,517, U.S. Pat. No. 4,930,324, U.S. Pat. No. 5,156,028, U.S. Pat. No. 5,794,464, U.S. Pat. No. 6,092,401, EP 0 862 677, WO 2006/040693 and US 2006/0169008.

These known devices however still have some inconveniences: in particular, there is the chance that cables get broken inside the device itself, and in particular inside the abutment plate, due to their excessive wear against component parts. Moreover, such devices have no automatic rewinding system for cables: in fact, when such devices are removed from a package to be protected, the cable slack must be recovered, always manually, by rotating a suitable handle or ring nut, such operation being able to become extremely frustrating for an operator, above all when such operation must be performed for a high number of devices and/or should the package size be particularly big and such as to generate a great cable slack. Moreover, in known devices, the safety systems or the adhesive Radio-Frequency (RF), electromagnetic (EM) or acoustic-magnetic (AM) labels are placed so that they can still be tampered with by some ill-intentioned person.

Moreover, in known devices, each cable has both its ends secured to the safety coil in such a way as to form a loop and a central portion of its passing by the abutment plate: in such arrangement, cables are made pass inside the plate in a substantially parallel way one to the other; this arrangement has the disadvantage of making the plate breakage or cutting potentially possible, without incurring in cables being cut, that can thereby be moved away in order to remove the package protected by the device without however that possible alarm systems are actuated.

Therefore, object of the present invention is providing an adjustable anti-theft device in which the slack of protecting cables is recovered through an automatic rewinding system.

Another object of the present invention is providing an adjustable anti-theft device in which the protecting cables are arranged in such a way as to prevent, or at least highly reduce, the chance of breakage due to wear.

Moreover, an object of the present invention is providing an adjustable anti-theft device in which the safety system or the adhesive Radio-Frequency (RE), electromagnetic (EM) or acoustic-magnetic (AM) labels are placed so that they cannot be reached from outside when the device itself is placed for protecting a product.

Another object of the present invention is providing an adjustable anti-theft device in which the protecting cables mutually cross at abutment plate level, making it impossible to remove the protected product, even in case of cutting or breakage of the plate itself.

The above and other objects and advantages of the invention, as will appear from the following description, are obtained with an anti-theft device as claimed in claim 1. Preferred embodiments and non-trivial variations of the present invention are the subject matter of the dependent claims.

It will be immediately obvious that numerous variations and modifications (for example related to shape, sizes, arrangements and parts with equivalent functionality) could be made to the described device, without departing from the scope of the invention as pointed out in the enclosed claims.

The present invention will be bette described by some preferred embodiments thereof, provided as a non-limiting example, with reference to the enclosed drawings, in which:

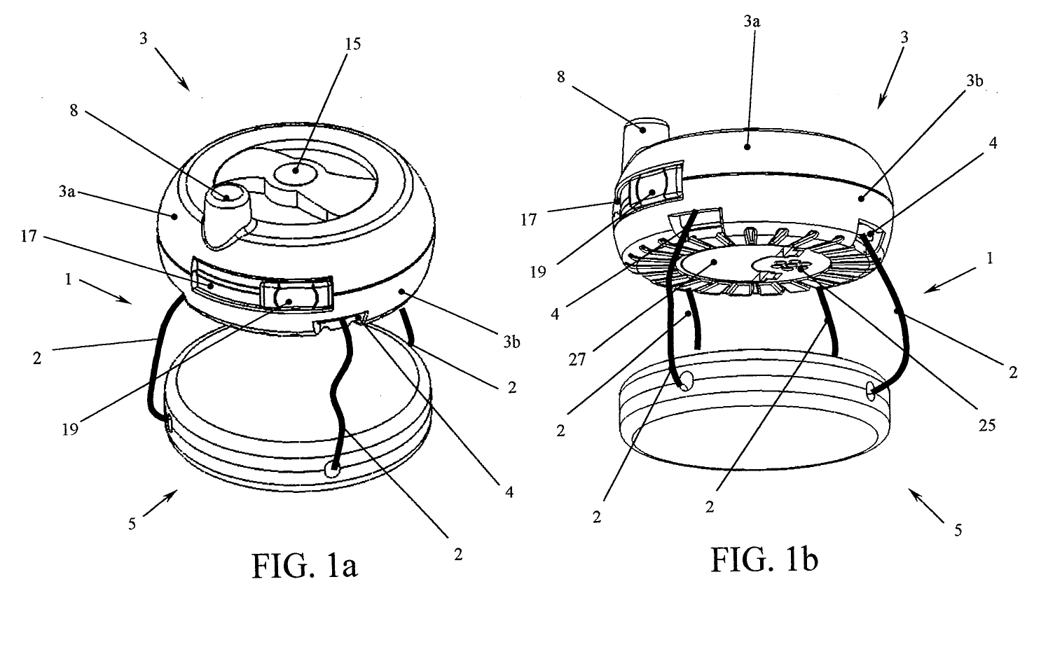

FIG. 1a shows a top perspective view of a preferred embodiment of the anti-theft device according to the present invention;

FIG. 1b shows a bottom perspective view of the anti-theft device of FIG. 1a;

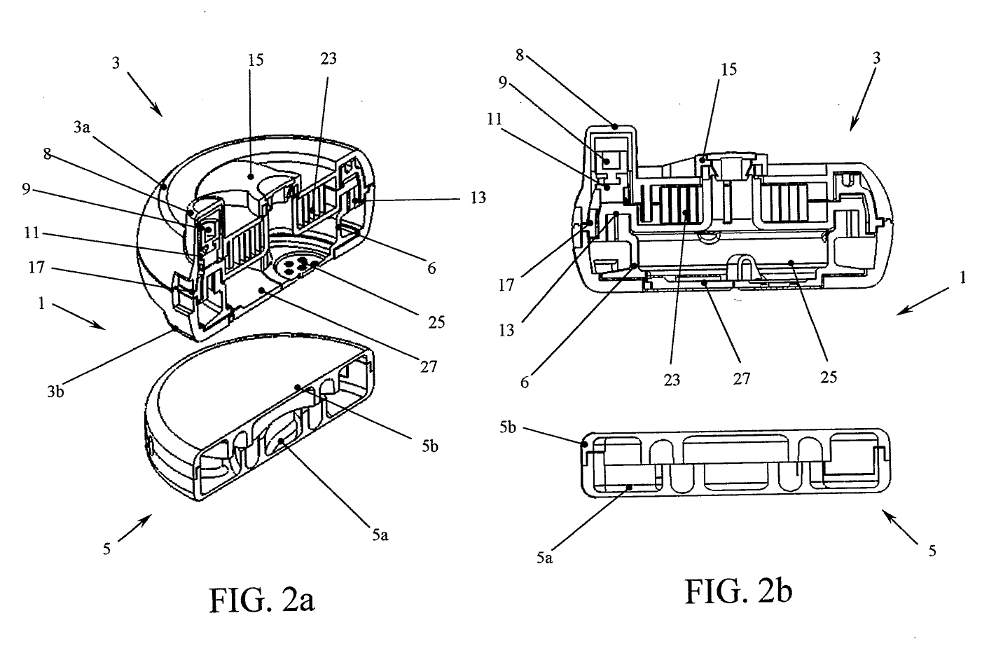

FIG. 2a shows a perspective sectional view of the anti-theft device of FIG. 1a;

FIG. 2b shows a sectional view of the anti-theft device of FIG. 1a;

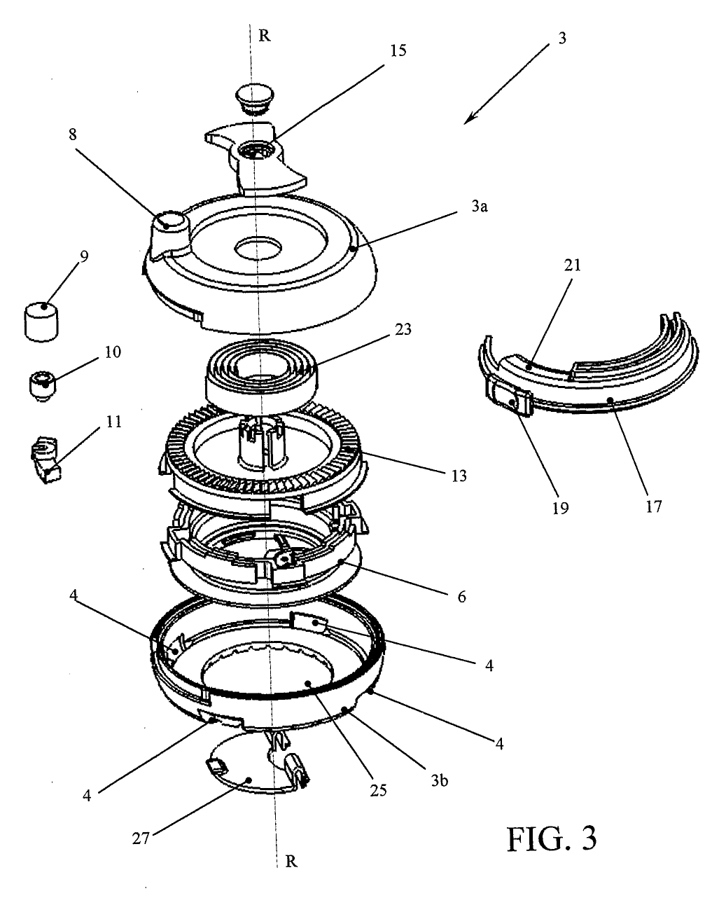

FIG. 3 shows an exploded view of the anti-theft device according to the present invention;

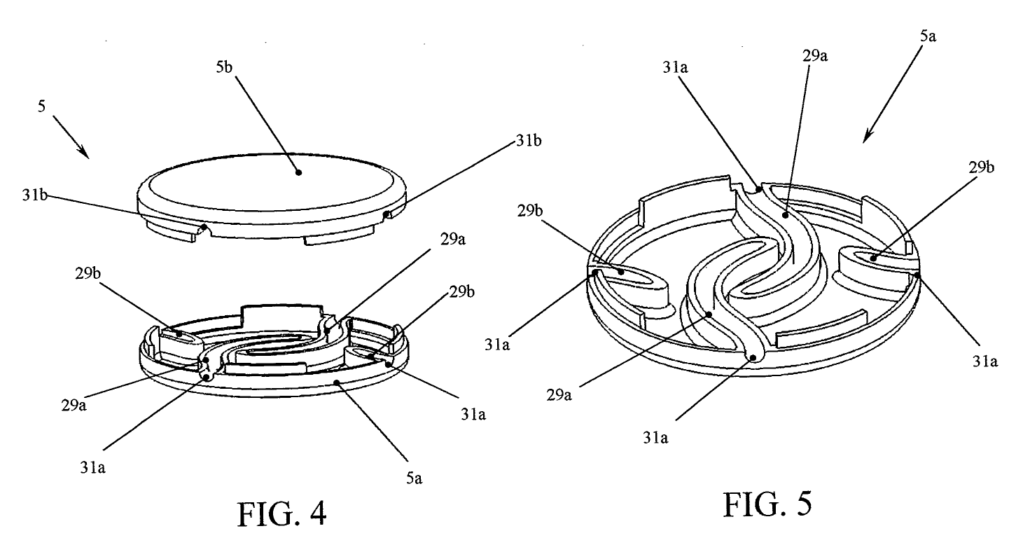

FIG. 4 shows a perspective view of a preferred embodiment of an element of the anti-theft device according to the present invention; and

FIG. 5 shows a perspective view of a preferred embodiment of a component of the element in FIG. 5.

With reference to the Figures, it is possible to note that the anti-theft device 1 according to the present invention is composed of an adjusting and blocking body 3 and of an abutment plate 5, the adjusting and blocking body 3 and the abutment plate 5 being mutually connected through at least two protecting cables 2 and mutually approaching and moving away by unwinding or winding such cables 2 from or on at least one winding coil 6 rotating inside the adjusting and blocking body 3, each cable 2 preferably having both its ends fastened to the winding coil 6 in order to form a loop and its central portion passing inside the abutment plate 5. The device 1 is further equipped with locking and unlocking means of the rotation of the coil 6, such locking and unlocking means being adapted to be magnetically attracted outside the adjusting and blocking body 3 in order to allow the coil 6 to rotate.

In particular, with reference to FIG. 3, it is possible to note that the adjusting and blocking body 3 is composed of an external casing, preferably composed by joining an upper half-case 3a and a lower half-case 3b, inside which the winding coil 6 is arranged, rotating around a rotation axis R-R. The lower half-case 3b is preferably equipped with a number of slits 4 adapted to allow the protecting cables 2 to go out from the body 3 to be joined with the abutment plate 5. On the perimeter, the winding coil 6 is equipped with fastening points (not shown) of the protecting cables 2 to be wound and unwound around it.

In a preferred embodiment thereof like the one shown in the Figures, the locking and unlocking means comprise at least one pin 9 capable of sliding inside a seat 8 thereof, preferably obtained in the upper half-case 3a, preferably made of iron but alternatively of any other ferromagnetic material, coaxial with elastic means, preferably a helical spring 10, to which a locking saw-shaped slider 11 is connected, or is an integral part thereof; on the perimeter of the winding coil 6, the locking and unlocking means further comprise at least one saw-shaped rail 13 with circular arrangement and rotating in agreement with the coil 6 around the rotation axis R-R, such rail 13 being adapted to be engaged by the slider 11.

In an alternative embodiment, not shown, of the locking and unlocking means, the sliding pin 9 is replaced by at least one known reduced-encumbrance blade for a magnetic detaching device of a substantially known type: in this way, the presence of the seat 8 is not necessary any more in the upper half-case 3a, and the device 1 according to the present invention globally has a more reduced encumbrance.

It is clear that the locking and unlocking means, instead of having a magnetic operation, could have a mechanical or electric/electronic operation, associated with a suitable detaching device, possibly also integrated in the device 1, without departing from the scope of the present invention.

In particular, the locking saw-shaped slider 11 and the saw-shaped rail 13 are equipped with saw teeth characterised by teeth whose shape is such as to allow their respective relative sliding, if cooperating along one direction, and the mutual locking, if cooperating along a reverse direction. Specifically, the saw teeth allow the relative sliding between locking saw-shaped slider 11 and saw-shaped rail 13 when the coil 6, and consequently the saw-shaped rail 13, rotate around the rotation axis R-R according to the winding direction of cables 2, while they generate their mutual locking when the coil 6, and consequently the saw-shaped rail 13, are taken to rotate around the rotation axis R-R along the unwinding direction of cables 2. Using a magnetically operating detaching device, of a substantially known type, it is possible, by attracting pin 9 through the housing 8 or the reduced-encumbrance blade, to disengage the locking saw-shaped slider 11 from the saw-shaped rail 13, thereby allowing their relative sliding and the unwinding of cables 2 from the coil 6, in particular to allow removing the anti-theft device 1 from the product (not shown) on which it is applied for protection. Winding of cables 2 around the coil 6 can be manually controlled by operating through control means outside the body 3, preferably made as at least one rotating ring nut 15 fastened to the coil 6 and coaxial with the rotation axis R-R.

In order to allow a free rotation of the coil 6 and a free winding/unwinding of cables 2 from the body 3, thereby without an intervention of the locking and unlocking means, the adjusting and blocking body 3 further comprises a sliding slider 17, that can be externally actuated by an operator acting on a push-button 19, such sliding slider 17 being equipped with an interposition portion 21 adapted to be taken, when necessary, between slider 11 and rail 13 in such a way as to prevent their cooperation. In particular, the sliding slider 17 can then at least be moved between a first position in which the interposition portion 21 is arranged between slider 11 and rail 13, and therefore the coil 6 can freely rotate around axis R-R in both directions, and a second position in which the interposition portion 21 is not placed between slider 11 and rail 13 that consequently are engaged according to the above-described modes, and therefore the coil 6 can rotate around the rotation axis R-R only according to the winding direction of cables 2.

Advantageously, the anti-theft device 1 according to the present invention is equipped with an automatic rewinding system of the protecting cables 2: such system preferably comprises elastic means, preferably made as at least one torsion spring 23 coaxial with the rotation axis R-R, preferably contained inside the coil 6, having a first end connected to the coil 6 itself, and a second end connected to a point of the casing of the body 3, preferably of the upper half-case 3a. Obviously, in order to allow the automatic recovery of the protecting cables 2, the elastic loading direction of the torsion spring 23 is in agreement with the rotation direction of the coil 6 determined by unwinding the cables 2 themselves. When the force that determines the unwinding of cables 2 ceases, the elastic force of the torsion spring 23 automatically rotates the coil 6 according to the winding direction, allowing to automatically recover the cables 2 slack, without having to manually operate on the ring nut 15. Moreover, the anti-theft device 1 according to the present invention can be equipped with a known alarm detecting system, for example made as at least one adhesive Radio-Frequency (RF), electromagnetic (EM) or acoustic-magnetic (AM) detecting label or their combinations. Moreover, the anti-theft device 1 can further be equipped with at least one electronic card equipped with sound alarm, possibly cooperating with the detecting system being present.

Advantageously, the alarm detecting system and/or the electronic card with sound alarm are arranged in a suitable housing 25 obtained in the lower half-case 3b of the adjusting and blocking body 3 whose single access is possible through the lower face of the lower half-case 3b, possibly through at least one protecting cover 27. Taking into account that the lower face of the lower half-case 3b is strictly in contact with the package of the product to be protected, when the anti-theft device 1 is applied to the package itself, it will be immediately clear that the alarm detecting system and/or the electronic card with sound alarm cannot be tampered with (for example by applying foams) without tampering with the package itself or the protecting cables 2, consequently making the alarm intervene.

Alternatively, it is possible to provide that the alarm detecting system and/or the electronic card with sound alarm are arranged inside the abutment plate 5.

With reference in particular to FIGS. 4 and 5, it is possible to note that a preferred embodiment of the abutment plate 5 is composed of at least two small plates 5a, 5b, substantially equal one to the other, each small plate 5a, 5b being equipped with passing guides 29a, 29b of the central portions of the protecting cables 2. Advantageously, in order to prevent the cables 2 from mutually overlapping and possibly scrubbing, that could bring about their quick wear and breakage, consequently impairing the optimum operating characteristics of the device 1, each passing guide 29a, 29b is curvilinear and radially arranged with respect to the small plate 5a, 5b with a substantially helical behaviour. In the particular case like the one shown as an example in the Figures, in which the protecting cables 2 of the anti-theft device 1 according to the present invention are two, the passing guides are divided into a pair of first passing guides 29a, mutually diametrically opposite, equipped with a double curvature and elongated till they exceed the centre of the base plate 5a, and a pair of second passing guides 29b, mutually diametrically opposite, shorter than the first passing guides 29a and equipped with one curvature only. Each passing guide 29a, 29b is equipped with an opening 31a towards outside through which the related protecting cable 2 is inserted. In particular, each opening 31a can have a semi-circular shape corresponding to a similar semi-circular opening 31b of the overlapped small plate 5b, the coupling of each pair of semi-circular openings 31a, 31b forming a circular opening for passing a protecting cable 2 therethrough. The abutment plate 5 is therefore formed by overlapping and joining, for example through engagement or gluing, the two small plates 5a, 5b mutually offset by an angle of 90°. In this way, the offset overlapping of the passing guides 29a, 29b of the respective small plates 5a, 5b substantially assumes the shape of a “X” that allows, inside the abutment plate 5, mutually crossing the central portions of the protecting cables 2, thereby making it impossible to remove the product protected by the device 1 even in case of cutting or breaking the plate 5.

Depending on what has been previously described, one of the possible operations of the anti-theft device 1 according to the present invention can, as an example, be as follows; in particular, in order to apply the device 1 around a package of a product:

disengage the locking saw-shaped slider 11 from the saw-shaped rail 13 by operating with the detaching device on the locking and unlocking means and take the sliding slider 17 to its first position to allow the free rotation of the coil 6 around the rotation axis R-R;

unwind the protecting cables 2 from the coil 6 through manual traction, by operating on the cables 2 themselves or on the abutment plate 5, till an adequate length is obtained for the sizes of the package to be protected;

arrange the abutment plate 5 and the protecting cables 2 along the respective faces of the package; when the traction on cables 2 stops, the automatic recovering system, and in particular the elastic force of the torsion spring 23 loaded when rotating the coil 6 for unwinding the cables 2, recovers the possible slack of the cables 2 themselves;

take the sliding slider 17 to its second position; in this way the slider 11 engages the rail 13 and the coil 6 can rotate around the rotation axis R-R only along the winding direction for cables 2;

possibly, tension the protecting cables 2 around the package by manually winding them around the coil 6 by rotating the ring nut 15.

After having ended the above operations, the anti-theft device 1 according to the present invention is strictly wound around the package and can be easily removed only through the intervention of the detaching device on the locking and unlocking means to disengage the slider 11 from the rail 13. In particular, in order to remove the device 1 from the package:

disengage the slider 11 from the rail 13 through the detaching device: in particular, the slider 11 is disengaged from the rail due to the magnetic attraction exerted by the detaching device itself on the pin 9 or on the reduced-encumbrance blade;

possibly, take the sliding slider 17 to its first position and manually unwind such a length of cables 2 as to allow the package to go out therefrom;

by releasing the tension on the cables 2, the automatic recovering system recover their slack and the device 1 according to the present invention is ready for a new use.

1-21. (canceled)

22. An anti-theft device comprising:
a) an adjusting and blocking body, where the adjusting and blocking body comprises one or more than one winding coil inside the adjusting and blocking body;
b) an abutment plate;
c) two or more than two protecting cables, where each protecting cable comprises a central portion flanked by two opposing ends;
where the adjusting and blocking body and the abutment plate are mutually connected through the two or more than two protecting cables;
where the adjusting and blocking body and the abutment plate mutually approach and go away from each other through unwinding or winding the protecting cables from or on the one or more than one winding coil rotating inside the adjusting and blocking body;
where the ends of each of the protecting cables are fastened to the winding coil and the central portion of the cable passes inside the abutment plate;
where the adjusting and blocking body further comprises a locking and unlocking structure for rotating the winding coil; and
where the adjusting and blocking body further comprises an automatic recovering system for removing slack from the protecting cables.

23. The anti-theft device of claim 22, where the adjusting and blocking body further comprises an upper half-case and a lower half-case, and where the winding coil is inside the lower half-case.

24. The anti-theft device of claim 23, where the lower half-case comprises slits for making the protecting cables go out from the adjusting and blocking body to join with the abutment plate.

25. The anti-theft device of claim 22, where the locking and unlocking structure comprise at least one pin comprising ferromagnetic material coaxial with an elastic structure, connected to a locking saw-shaped slider, and at least one saw-shaped rail on the perimeter and integral with the winding coil, the rail being adapted to be engaged by the slider.

26. The anti-theft device of claim 22, where the locking and unlocking structure comprise one or more than one blade and comprising ferromagnetic material, the one or more than one blade cooperating with a locking saw-shaped slider, and at least one saw-shaped rail on the perimeter and integral with the winding coil, the rail being adapted to be engaged by the slider.

27. The anti-theft device of claim 22, where the adjusting and blocking body further comprises at least one rotating ring nut integral with the coil for winding the protecting cables.

28. The anti-theft device of claim 22, where the adjusting and blocking body further comprises a sliding slider that can be actuated from outside the adjusting and blocking body and comprises an interposition portion adapted to be taken between the slider and the rail in such a way as to prevent the slider and the rail from cooperating.

29. The anti-theft device of claim 22, where the automatic recovering system of the protecting cables comprises one or more than one torsion spring coaxial with a rotation axis of the coil, the torsion spring comprising a first end connected to the coil and a second end connected to a point of the adjusting and blocking body.

30. The anti-theft device of claim 29, where an elastic loading direction of the torsion spring is the same as a rotation direction of the coil around the rotation axis determined by the unwinding of the cables.

31. The anti-theft device of claim 22, where the adjusting and blocking body, or the abutment plate, or both the adjusting and blocking body and the abutment plate comprise an alarm detecting system.

32. The anti-theft device of claim 31, where the alarm detecting system is selected from the group consisting of an adhesive Radio-Frequency, an electromagnetic detecting label, an acoustic-magnetic detecting label, and a combination of the preceding.

33. The anti-theft device of claim 22, where the adjusting and blocking body, or the abutment plate, or both the adjusting and blocking body and the abutment plate comprise one or more than one electronic card equipped with sound alarm.

34. The anti-theft device of claim 22, where the abutment plate comprises a 90°-offset overlapping two or more than two small plates, where each of the small plates comprises passing guides for the protecting cables.

35. The anti-theft device of claim 34, where the passing guide is curvilinear and radially arranged with respect to one or more than one of the small plates, and where the passing guide extends along a helical path.

36. The anti-theft device of claim 34, where the passing guides comprise one or more than one pair of first passing guides, the first passing guides being mutually diametrically opposite, and where the first passing guides comprise a double curvature and are elongated until the passing guides pass the center of the small plate.

37. The anti-theft device of claim 36, where the passing guides further comprise one or more than one pair of second passing guides, the second passing guides being mutually diametrically opposite, and where the second passing guides are shorter than the first passing guides and where the second passing guides comprise only one curvature.

38. The anti-theft device of claim 34, where each of the passing guides comprises one or more than one opening for inserting the protecting cable.
